(19) United States
(12) Patent Application Publication
(10) Pub. No.: US 2014/0082486 A1
(43) Pub. Date: Mar. 20, 2014

(54) SYSTEM FOR PRECISELY POSITIONING DOCUMENT PAGE NUMBER OF HANDHELD APPARATUS AND METHOD THEREOF

(71) Applicants: INVENTEC (PUDONG) TECHNOLOGY CORPORATION, (US); INVENTEC CORPORATION, Taipei (TW)

(72) Inventor: Ke DING, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/804,341

(22) Filed: Mar. 14, 2013

(30) Foreign Application Priority Data
Sep. 18, 2012 (CN) 201210348044.4

(51) Int. Cl. G06F 17/21

(52) U.S. Cl. CPC G06F 17/217
USPC 715/251

(57) ABSTRACT

A system for precisely positioning a document page number of a handheld apparatus and a method thereof are provided. When a document is opened, a sliding positioning element is provided, and an adjustment range is calculated according to a current page number of the document, so that the sliding positioning element achieves the technical efficacy of precisely positioning a page number of document content in the calculated adjustment range.

### BACKGROUND OF THE INVENTION

1. Field of the Invention

The present invention relates to a positioning system and a method thereof, and more particularly to a system for precisely positioning a document page number of a handheld apparatus and a method thereof.

2. Description of Related Art

Development and application of handheld apparatuses are quite quick. Mobile phones and personal digital assistants (PDAs) in the early stage are developed to tablet computers and smart phones, so that people cannot depart from the convenience brought by the handheld apparatus in daily life.

The handheld apparatus in the early stage is controlled and operated in a keying manner, but the keying manner may occupy much space, which indirectly limits a display screen of the handheld apparatus.

In recent days, with development of a touch panel technology, the existing handheld apparatus (for example, the tablet computer and the smart phone) is controlled and operated in a touch manner instead of the keying manner, so that a relatively wide screen may be used on the handheld apparatus, which enables a user to more conveniently use and operate the handheld apparatus.

For viewing document content on the handheld apparatus, when a maximum page number of the document content is not large (for example, a document with a maximum page number less than 20), the user may select a page to be read through the touch operation, and when the maximum page number of the document content is relatively large (for example, a document with a maximum page number less than 200), the user needs to selectively position a page to be read through a sliding element. However, when the maximum page number of the document content is large (for example, a document with a maximum page number greater than 1000), a precision of the sliding element at this time is lowered to an unacceptable level. For example, when the sliding element is shifted by 2 millimeters, a resulted page number error is up to hundreds of pages, so it is a serious problem to selectively position the page number when the maximum page number of the document content is large.

To sum up, it may be known that in the prior art, a problem that when a document with a large maximum page number is read on an existing handheld apparatus, it is impossible to precisely selectively position the page number of the document content, exists in a long term, so it is necessary to propose an improved technical means to solve the problem.

### SUMMARY OF THE INVENTION

In view of the problem existing in the prior art that when a document with a large maximum page number is read on an existing handheld apparatus, it is impossible to precisely selectively position a page number of the document content, a system for precisely positioning a document page number of a handheld apparatus and a method thereof are disclosed in the present invention.

In the system for precisely positioning a document page number of a handheld apparatus disclosed in the present invention, the handheld apparatus performs operation control through a touch display apparatus, and the system includes a page number module, a calculating module, and an element module.

The page number module provides a sliding element, in which a sliding range of the sliding element is from a first page to a last page of the document page number, slides the sliding element to an adjacent position of a target page number, and is used to receive a current page number of the document; the calculating module is used to calculate an adjustment range according to the current page number of the document and a range value, wherein the range value is calculated through a maximum page number of the document and a range rate; and the element module is used to provide a sliding positioning element, sliding the sliding positioning element to the target page number, wherein a sliding range of the sliding positioning element is the adjustment range, so as to precisely position the document page number.

In the method for precisely positioning a document page number of a handheld apparatus disclosed in the present invention, the handheld apparatus performs operation control through a touch display apparatus, and the method includes the following steps.

First, a sliding element is provided, in which a sliding range of the sliding element is from a first page to a last page of the document page number, the sliding element is slid to an adjacent position of a target page number, and a current page number of the document is received; next, an adjustment range is calculated according to the current page number of the document and a range value, wherein the range value is calculated through a maximum pagination and a range rate; and finally, a sliding positioning element is provided, the sliding positioning element slides to the target page number, wherein a sliding range of the sliding positioning element is the adjustment range, so as to precisely position the document page number.

The system and the method disclosed in the present invention are described above. The difference from the prior art is that in the present invention, when a document is opened, a user slides a sliding element to an adjacent position of a target page number, a current page number of the document is received, a range value is calculated according to a maximum page number of the document and a range rate, an adjustment range is calculated according to the current page number of the document and the range value, a sliding positioning element is provided, and the user slides the sliding positioning element in the adjustment range, so that the sliding positioning element slides to the target page number, so as to precisely position a document page number.

Through the foregoing technical means, the present invention may achieve the technical efficacy of precisely positioning a page number of document content in a handheld apparatus.

### BRIEF DESCRIPTION OF THE DRAWINGS

The invention will become more fully understood from the detailed description given herein below illustration only, and thus is not limitative of the present invention, and wherein:

FIG. 1 is a block diagram of a system for precisely positioning a document page number of a handheld apparatus according to the present invention.

FIG. 2 is a flow chart of a method for precisely positioning a document page number of a handheld apparatus according to the present invention.

FIG. 3A and FIG. 3B are schematic exploded views of an operation of precisely positioning a document page number of a handheld apparatus according to the present invention.

### DESCRIPTION OF THE EMBODIMENTS

Implementation manners of the present invention are illustrated in detail below with reference to accompanying drawings and embodiments, so the implementation procedure about how technical means is applied to the present invention to solve the technical problem and achieve the technical efficacy can be fully understood and implemented accordingly.

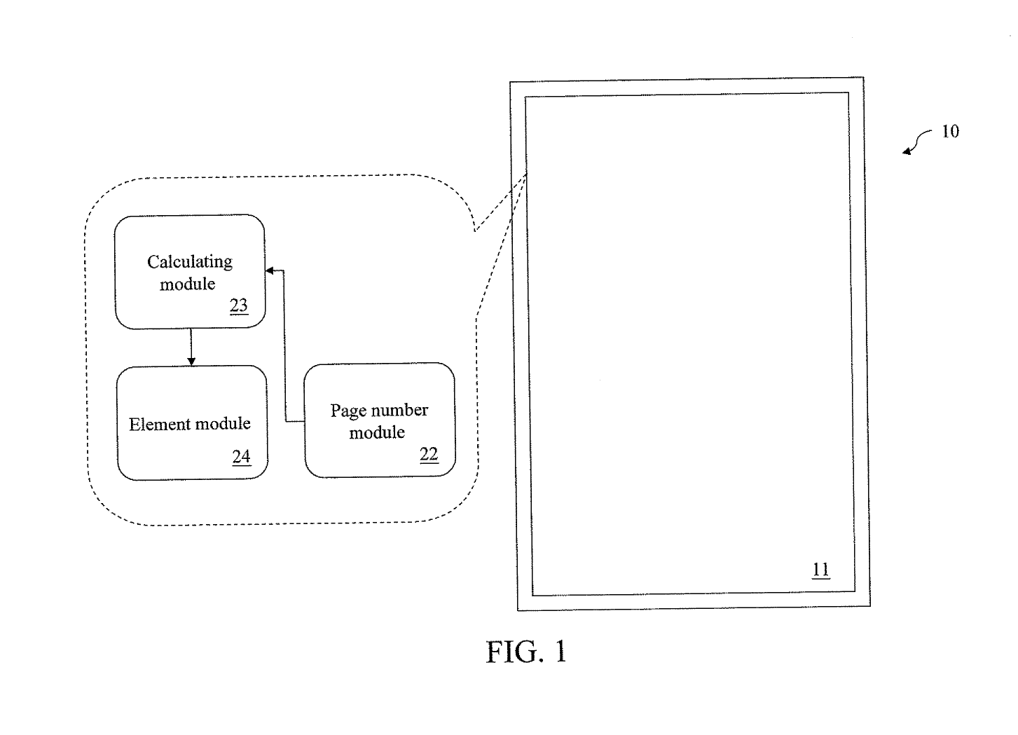

First, a system for precisely positioning a document page number of a handheld apparatus disclosed in the present invention is described. Referring to FIG. 1, it is a block diagram of a system for precisely positioning a document page number of a handheld apparatus according to the present invention.

In the system for precisely positioning a document page number of a handheld apparatus disclosed in the present invention, the handheld apparatus 10 performs operation control through a touch display apparatus 11, and the system includes: a page number module 22, a calculating module 23, and an element module 24.

When a user opens a document with a large page number in the handheld apparatus 10, a maximum page number of document content is large (for example, the maximum page number of the document is greater than 1000, which is exemplarily described, but the application scope of the present invention is not limited thereto), so a precision of the sliding element at this time is lowered to an unacceptable level, so that each time when the sliding element slides by 1 unit (for example: 1 millimeter, 10 pixels, and so on), the sliding element may adjust the document page number according to a sliding error, and a sliding range of the sliding element is from a first page to a last page of the document pages.

Particularly, suppose that a current page number is “10”, when the sliding error is “250”, when the user slides the sliding element by 1 unit, the current page number “10” is adjusted to a page number “260”.

The user can only slide the sliding element to an adjacent position of a target page number, and the target page number is a number of a page of the document required to be read by the user. For example, suppose that the target page number is “1588” and a sliding error of the sliding element is “250”, an adjacent position of the target page number “1588” to which the user slides the sliding element is “1500”, which is exemplarily described, but the application scope of the present invention is not limited thereto.

The sliding error is calculated by multiplying a maximum page number of the document by a range rate. Particularly, suppose that the maximum page number of the document is “5000” and the range rate “5%”, the calculated sliding error is “250” (that is, 5000×5%=250).

When the user slides the sliding element to the adjacent position of the target page number, the page number module 22 may receive a current page number of the document of the adjacent position of the target page number to which the user slides the sliding element.

Next, a range value is calculated according to the maximum page number of the document and the range rate, that is, the range value is calculated by multiplying the maximum page number of the document by the range rate. Particularly, suppose that the maximum page number of the document is “5000” and the range rate is “5%”, the range value calculated by the calculating module 23 is “250” (that is, 5000×5%=250).

When the page number module 22 receives the current page number of the document being a page number of a common page (that is, a page being not a start page or an end page), a first numeral is calculated by subtracting the range value from the current page number of the document, and a second numeral is calculated by adding the range value to the current page number of the document, in which a range between the first numeral and the second numeral is the adjustment range.

In view of the above mentioned, for example, suppose that the current page number of the document received by the page number module 22 is “1800”, the range value calculated by the calculating module 23 is “250”, the first numeral calculated by the calculating module 23 is “1550” (that is, 1800−250=1550), and the second numeral calculated by the calculating module 23 is “2050” (that is, 1800+250=2050), the adjustment range is from the first numeral “1550” to the second numeral “2050”.

When the page number module 22 receives the current page number of the document being a page number of the start page, the adjustment range is calculated by using the current page number of the document and adding two times of the range value to the current page number of the document.

In view of the above mentioned, for example, suppose that the current page number of the document received by the page number module 22 is “1” (that is, the page number of the start page), and the range value calculated by the calculating module 23 is “250”, the adjustment range calculated by the calculating module 23 is from “1” to “501” (that is, 1+2×250=501).

When the page number module 22 receives the current page number of the document being a page number of the end page, the adjustment range is calculated by using the current page number of the document and subtracting two times of the range value from the current page number of the document.

In view of the above mentioned, for example, suppose the current page number of the document received by the page number module 22 is “5000” (that is, the page number of the end page), and the range value calculated by the calculating module 23 is “250”, the adjustment range calculated by the calculating module 23 is from “4500” (that is, 5000−2×250=4500) to “5000”.

It should be noted that the adjustment range calculated by the calculating module 23 includes the current page number of the document and the target page number.

Next, the element module 24 provides a sliding positioning element, and the user may slide the sliding positioning element in the adjustment range calculated by the calculating module 23 (that is, a sliding range of the sliding positioning element is the adjustment range), so that the sliding positioning element slides to the target page number, so as to precisely position the document page number.

Particularly, suppose that adjustment range calculated by the calculating module 23 is from “1500” to “2500”, the user may slide the sliding positioning element to the target page number “1588” in the range from “1500” to “2500”, so as to precisely position the document page number.

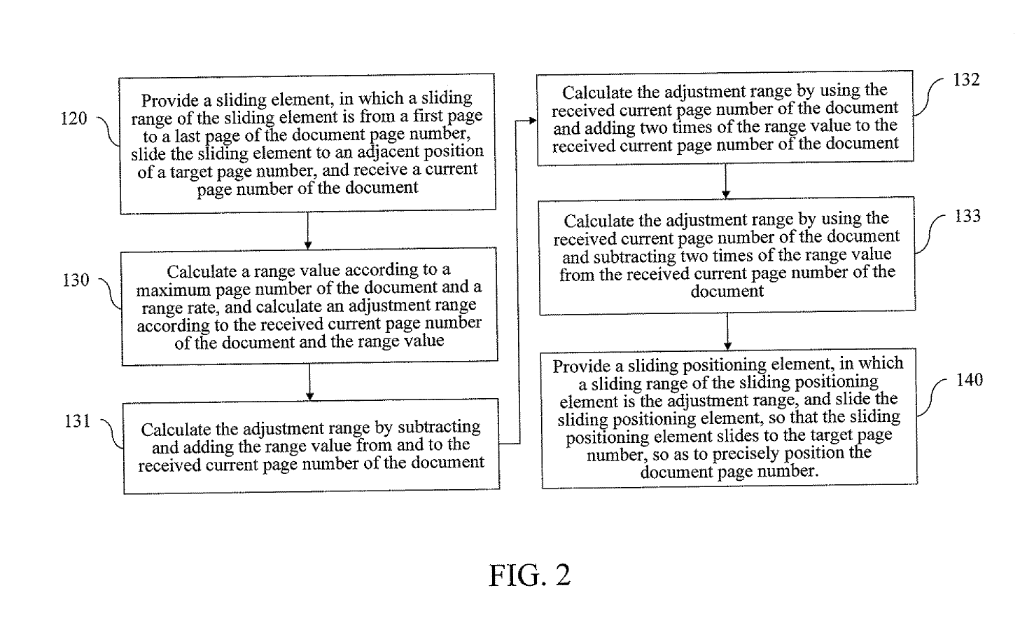

Next, an operation manner and a process of the present invention are illustrated by using an embodiment in the following. The embodiment in the following is descried in combination with FIG. 1 and FIG. 2. FIG. 2 is a flow chart of a method for precisely positioning a document page number of a handheld apparatus according to the present invention.

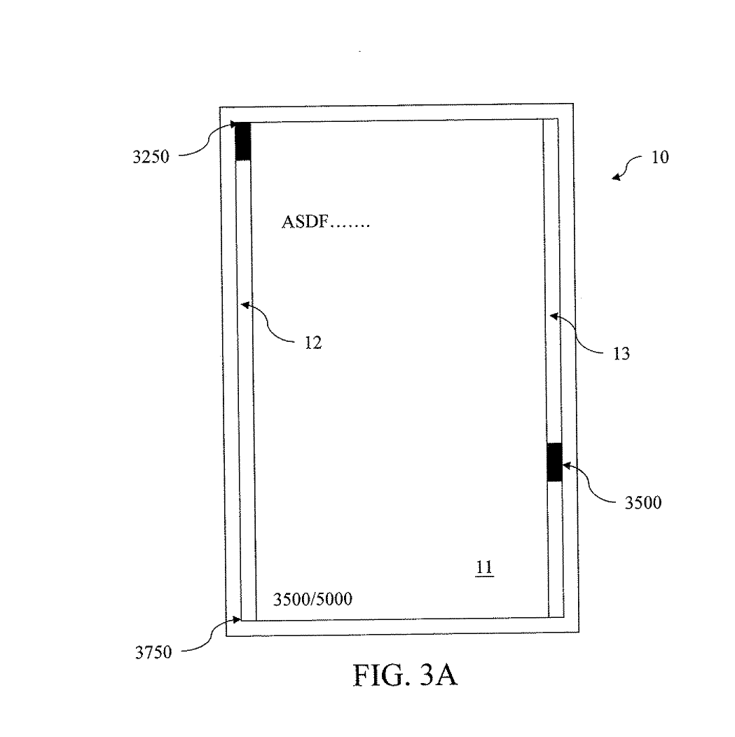

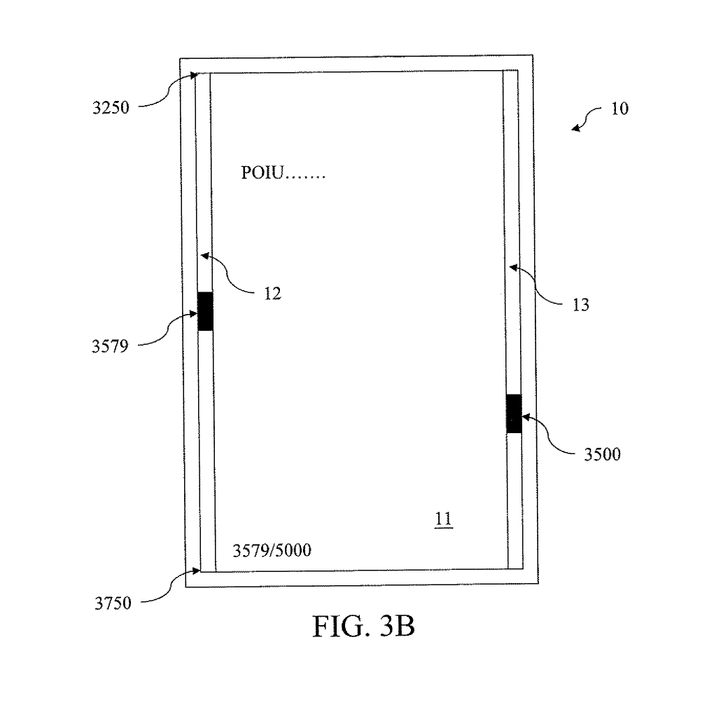

Next, referring to FIG. 3A and FIG. 3B, FIG. 3A and FIG. 3B are schematic exploded views of an operation of precisely positioning a document page number of a handheld apparatus according to the present invention.

When a user opens a document with the number of pages being 5000 in the handheld apparatus 10, a maximum page number of the document is “5000” and a range rate is preset to be “5%”, so a calculated sliding error is “250” (that is, 5000×5%=250). Suppose that the user needs to read the content in the 3579^{th} page of the document, the user moves the sliding element 13 to the 3500^{th} page of the document in a touch manner. At this time, the page number module 22 receives a current page number “3500” of the document (as shown in FIG. 3A, Step 120). Since the maximum page number of the document is “5000” and the range rate is preset to be “5%”, a range value calculated by the calculating module 23 is “250” (that is, 5000×5%=250).

Since the page number module 22 receives the current page number “3500” of the document and the range value calculated by the calculating module 23 is “250”, a first numeral calculated by the calculating module 23 is “3250” (that is, 3500−250=3250), a second numeral calculated by the calculating module 23 is “3750” (that is, 3500+250 =3750), and an adjustment range is from the first numeral “3250” to the second numeral “3750” (Step 130, Step 131).

Next, the element module 24 provides the sliding positioning element 12, and the user slides the sliding positioning element 12 in the adjustment range, from “3250” to “3750”, calculated by the calculating module 23, so that the sliding positioning element 12 slides to a target page number “3579” (Step 140), so as to precisely position the document page number “3579”.

In addition, when the page number module 22 receives a current page number “1” of the document (that is, a page number of a start page) and the range value calculated by the calculating module 23 is “250”, an adjustment range calculated by the calculating module 23 is from “1” to “501” (that is, 1+2×250=501) (Step 132), and the sliding positioning element provided by the element module 24 may quickly and precisely position a document page number in document page numbers from “1” to “501”.

In addition, the page number module 22 receives a current page number “5000” of the document (that is, a page number of an end page) and the range value calculated by the calculating module 23 is “250”, an adjustment range calculated by the calculating module 23 is from “4500” (that is, 5000−2×250=4500) to “5000” (Step 133), and the sliding positioning element provided by the element module 24 may quickly and precisely position a document page number in document page numbers from “4500” to “5000”.

To sum up, it may be known that a difference between the present invention and the prior art is that in the present invention, when a document is opened, a user slides a sliding element to an adjacent position of a target page number, a current page number of the document is received, a range value is calculated according to a maximum page number of the document and a range rate, an adjustment range is calculated according to the current page number of the document and the range value, a sliding positioning element is provided, and the user slides the sliding positioning element in the adjustment range, so that the sliding positioning element slides to the target page number, so as to precisely position a document page number.

The technical means solves the problem existing in the prior art that when a document with a large maximum page number is read on an existing handheld apparatus, it is impossible to precisely selectively position a page number of the document content, so as to achieve the technical efficacy of precisely positioning the page number of the document content in the handheld apparatus.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A system for precisely positioning a document pagination of a handheld apparatus, the system comprising:
a pagination module, providing a sliding element, wherein a sliding range of the sliding element is from a first page to a last page of the document, sliding the sliding element to an adjacent position of a target pagination and receiving a current pagination;
a calculating module, calculating an adjustment range according to the current pagination and a range value, wherein the range value is calculated through a maximum pagination and a range rate; and
an element module, providing a sliding positioning element, sliding the sliding positioning element to the target pagination, wherein a sliding range of the sliding positioning element is the adjustment range, so as to precisely position the document pagination.

2. The system for precisely positioning a document pagination of a handheld apparatus according to claim 1, wherein the calculating module calculates a first numeral by subtracting the range value from the current pagination of the document, and calculates a second numeral by adding the range value to the current pagination of the document, and a range between the first numeral and the second numeral is the adjustment range.

3. The system for precisely positioning a document pagination of a handheld apparatus according to claim 1, wherein when the current pagination of the document is a home page, the calculating module calculates the adjustment range by using the current pagination of the document and adding two times of the range value to the current pagination of the document.

4. The system for precisely positioning a document pagination of a handheld apparatus according to claim 1, wherein when the current pagination of the document is an end page, the calculating module calculates the adjustment range by using the current pagination of the document and subtracting two times of the range value from the current pagination of the document.

5. The system for precisely positioning a document pagination of a handheld apparatus according to claim 1, wherein the adjustment range comprises the current pagination and the target pagination.

6. A method for precisely positioning a document pagination of a handheld apparatus, the method comprising:
providing a sliding element, wherein a sliding range of the sliding element is from a first page to a last page of the document , sliding the sliding element to an adjacent position of a target pagination, and receiving a current pagination;
calculating an adjustment range according to the current pagination and a range value, wherein the range value is calculated through a maximum pagination and a range rate; and
providing a sliding positioning element, sliding the sliding positioning element to the target pagination, wherein a sliding range of the sliding positioning element is the adjustment range, so as to precisely position the document pagination.

7. The method for precisely positioning a document pagination of a handheld apparatus according to claim 6, a first numeral is calculated by subtracting the range value from the current pagination of the document, a second numeral is calculated by adding the range value to the current pagination of the document, and a range between the first numeral and the second numeral is the adjustment range.

8. The method for precisely positioning a document pagination of a handheld apparatus according to claim 6, when the current pagination of the document is a home page, the adjustment range is calculated by using the current pagination of the document and adding two times of the range value to the current pagination of the document.

9. The method for precisely positioning a document pagination of a handheld apparatus according to claim 6, when the current pagination of the document is an end page, the adjustment range is calculated by using the current pagination of the document and subtracting two times of the range value from the current pagination of the document.

10. The method for precisely positioning a document pagination of a handheld apparatus according to claim 6, the adjustment range comprises the current pagination of the document and the target pagination.
